(19) United States
(12) Patent Application Publication
(10) Pub. No.: US 2013/0212428 A1
(43) Pub. Date: Aug. 15, 2013

(54) INFORMATION STORAGE MEDIUM LIBRARY ARRAY APPARATUS, INFORMATION RECORDING METHOD AND INFORMATION RECORDING PROGRAM

(71) Applicants: Yoshikazu Yamamoto, Osaka (JP); Yoshihisa Takahashi, Osaka (JP)

(72) Inventors: Yoshikazu Yamamoto, Osaka (JP); Yoshihisa Takahashi, Osaka (JP)

(21) Appl. No.: 13/878,641

(22) PCT Filed: Sep. 5, 2012
(86) PCT No.: PCT/JP2012/005615

§ 371 Date: Apr. 10, 2013

(30) Foreign Application Priority Data
Sep. 14, 2011 (JP) 2011-200476

(51) Int. Cl. G06F 11/20

(52) U.S. Cl. CPC G06F 11/2046
USPC 714/6.21

(57) ABSTRACT

Each of a plurality of information storage media and an alternative information storage medium record data continuously on tracks, each of a plurality of recording and reproduction devices record data on the information storage medium that is a recording object, of the plurality of information storage media, and the information storage media installed respectively in the plurality of recording and reproduction devices constitute a disk array, and the array controller detects the occurrence of a fault in which the information storage medium installed in any of the plurality of recording and reproduction devices has become unable to perform recording, and the backup recording and reproduction device alternatively records to the alternative information storage medium data that ought to be recorded to a faulty information storage medium where the occurrence of a fault has been detected by the array controller.

### TECHNICAL FIELD

The present invention relates to an information storage medium library array apparatus, an information recording method and an information recording program, in which a disk array is constructed by using a plurality of removable information storage media, such as optical disks, and data is recorded in a distributed fashion to the plurality of removable information storage media.

### BACKGROUND ART

A disk array apparatus is an external storage apparatus for achieving high storage capacity, fast processing and improved fault tolerance, which is used in large-scale commercial servers or other computer systems. In a disk array apparatus, the level of the RAID (Redundant Arrays of Inexpensive Disks) to be used is selected in accordance with the required reliability, speed and use efficiency. Commonly used RAID levels are RAID 0 which has a striping function only, RAID 1 which has a mirroring function, RAID 5 which records a parity calculated in block units, in a distributed fashion, RAID 6 which records two types of parity calculated in block units, in a distributed fashion, and so on. Furthermore, a method which combines these RAID levels, for example, RAID 10 which stripes mirrored groups, is also used.

Here, RAID 5, which ensures redundancy and is used commonly in scenarios where high speed and use efficiency are required, will be described.

FIG. 10 is a diagram for describing a RAID 5 system. FIG. 10 shows an example of a RAID 5 system which is constituted by four disk devices 201 to 204. In a RAID, the memory area of each disk device is managed by being divided into blocks of a size that is the same as the logical sector size, or a multiple of the logical sector size. The block size is called the stripe size. In FIG. 10, the blocks Ai, Bi, Ci and Pi (where i=1, 2, 3, . . . ) constitute one stripe. The block Pi is a parity block. Block Pi stores exclusive OR calculation results for the data located at the same byte positions in the blocks Ai, Bi and Ci.

In RAID 5, data can be restored even when one disk device has a fault, or the like, and cannot reproduce data. For example, let it be supposed that the disk device 203 in FIG. 10 is suffering a fault and can no longer reproduce data. In this case, the block C1 can be restored by calculating an exclusive OR of the data situated at the same byte position in blocks A1, B1 and P1.

A disk array apparatus of this kind also employs a system which uses storage devices of a removable medium type, as external storage devices. A system which uses storage devices of a removable medium type employs a library apparatus which includes an accommodating body that accommodates a plurality of information storage media, one or a plurality of recording and reproduction devices to which data is written and from which data is read out, and a conveyance body which conveys the information storage media between the accommodating body and the recording and reproduction devices. A system which constitutes an array by combining a plurality of library apparatuses of this kind is also called RAIL (Redundant Arrays of Inexpensive Libraries).

In recent years, the volume of data stored in large-scale data centers has increased dramatically, and in conjunction with this, the volume of data that is referenced infrequently has also tended to increase. Attention has been drawn to a library apparatus of a removable medium type which is capable of reducing power consumption, as a device for archiving data of this kind which is referenced infrequently.

A typical example of a removable type of information storage medium is an optical disk, such as a DVD (Digital Versatile Disc) or Blu-ray Disc. Broadly speaking, optical disks can be divided into rewriteable information storage media, such as DVD-RAM and BD-RE, and write-once information storage media, such as DVD-R, DVD+R and BD-R.

With the increase in the storage capacity of optical disks over recent years, there have been an increasing number of situations where inexpensive write-once information storage media are used for archiving data which is referenced infrequently.

In a library array apparatus of a removable medium type, a RAID is constructed by a set of information storage media which are installed in the recording and reproduction devices in the respective library apparatuses, and it is possible to use a set of information storage media of greater number than the number of recording and reproduction devices provided in the library apparatuses, by changing the information storage media which are installed in the recording and reproduction devices in the respective library apparatuses.

If a fault occurs in an information storage medium and the information storage medium in which the fault has occurred is to be recovered, then it is necessary to install the set of information storage media including the information storage medium which has suffered a fault, in the recording and reproduction devices in the library apparatuses. Therefore, in the recording and reproduction device which is used for recovery, it is only possible to record and reproduce data to and from the information storage medium set including the information storage medium to be recovered. In particular, if there is one recording and reproduction device in each of the library apparatuses, then during recovery, it is completely impossible to record and reproduce data to and from any information storage media other than the information storage media set which includes the information storage medium that is being recovered.

Therefore, a disk array apparatus provided with a backup recording and reproduction device and a backup information storage medium has been proposed (see Patent Literature 1, for example). This disk array apparatus reproduces data from the information storage medium in which a fault has occurred, and records the reproduced data on the backup information storage medium installed in the backup recording and reproduction device, if an update request has been made in respect of the information storage medium in which a fault has occurred. Therefore, the recovery time is shortened.

However, a conventional disk array apparatus uses rewriteable removable information storage media. A rewriteable removable information storage medium is not limited to writing data continuously to a user area, but rather data is written to any desired position of the user area, by designating an address. Therefore, with a rewriteable removable information storage medium, data management is difficult and data recording and reproduction takes time, which means that it is difficult to continue recording and reproduction readily.

### CITATION LIST

### Patent Literature

Patent Literature 1: Japanese Patent Application Publication No. 2001-27937

### SUMMARY OF THE INVENTION

The present invention was devised in view of the problems described above, an object thereof being to provide an information storage medium library array apparatus, an information recording method and an information recording program, whereby recording and reproduction can be continued readily, without causing performance to decline, even in a state where an information storage medium has become unable to perform recording.

The information storage medium library array apparatus relating to one aspect of the present invention is an information storage medium library array apparatus which records data to a plurality of information storage media and an alternative information storage medium which is a substitute for one of the plurality of information storage media, wherein each of the plurality of information storage media and the alternative information storage medium record data continuously on tracks, the information storage medium library array apparatus including: a plurality of recording and reproduction devices which record data to the information storage media and also reproduce data from the information storage media; a backup recording and reproduction device which records data to the alternative information storage media and also reproduces data from the alternative information storage media; and a control unit which controls operations of the plurality of recording and reproduction devices and the backup recording and reproduction device, and controls the plurality of recording and reproduction devices so as to record the data, in a distributed fashion, to the plurality of information storage media, wherein the plurality of recording and reproduction devices each record the data to the information storage medium that is a recording object, of the plurality of information storage media; the information storage media installed respectively in the plurality of recording and reproduction devices constitute a disk array; the control unit detects that a fault has occurred in which the information storage medium installed in any one of the plurality of recording and reproduction devices has become unable to perform recording; and the backup recording and reproduction device alternatively records to the alternative information storage medium data that ought to be recorded to a faulty information storage medium in which the occurrence of a fault has been detected by the control unit.

According to this composition, each of the plurality of information storage media and the alternative information storage medium record data continuously on tracks. The plurality of recording and reproduction devices record data to the information storage media and also reproduce data from the information storage media. The backup recording and reproduction device records data to the alternative information storage medium and also reproduces data from the alternative information storage medium. The control unit controls the plurality of recording and reproduction devices and the backup recording and reproduction device, and controls operations of the plurality of recording and reproduction devices so as to record the data in a distributed fashion on the plurality of information storage media. The plurality of recording and reproduction devices each record the data to the information storage medium that is a recording object, of the plurality of information storage media. Each of the information storage media installed respectively in the plurality of recording and reproduction devices constitute a disk array. The control unit detects that a fault has occurred where the information storage medium installed in any one of the plurality of recording and reproduction devices has become unable to perform recording. The backup recording and reproduction device alternatively records data that ought to be recorded to a faulty information storage medium in which the occurrence of a fault has been detected by the control unit, to the alternative information storage medium.

According to the present invention, since the data that ought to be recorded to a faulty information storage medium in which the occurrence of a fault has been detected is recorded alternatively to the alternative information storage medium, then it is possible to continue recording and reproduction readily, without decline in performance, even if an information storage medium constituting the disk array has become unable to perform recording.

The objects, characteristics and advantages of the present invention will become more apparent from the following detailed description and accompanying drawings.

### BRIEF DESCRIPTION OF THE DRAWINGS

FIG. 1 is a drawing showing a composition of an information storage medium library array apparatus according to a first embodiment of the present invention.

FIG. 2 is a diagram showing one example of a state of the recording areas of the medium Ai, the medium Bi, the medium Ci and the medium Di, when the medium Ci has become unable to perform recording, during operation.

FIG. 3 is a diagram showing one example of the state of the recording areas of the medium Ai, the medium Bi, the medium Ci, the medium Di and the medium Ej, when the medium Ej is installed in a backup recording and reproduction device.

FIG. 4 is a diagram showing one example of the state of the recording areas of the medium Ai, the medium Bi, the medium Ci, the medium Di and the medium Ej, when data that ought to be recorded to the medium Ci is recorded alternatively to the medium Ej.

FIG. 5 is a flowchart showing one example of a recording operation of information storage medium library array apparatus according to the first embodiment of the present invention.

FIG. 6 is a flowchart showing a recording operation or a reproduction operation in relation to a recording request or a reproduction request in the information storage medium library array apparatus according to the first embodiment of the present invention.

FIG. 7 is a flowchart for describing a process of copying from a faulty medium to an alternative medium in an information storage medium library array apparatus according to the first embodiment of the present invention.

FIG. 8 is a diagram showing a state of recording areas before copying data from a medium Ci which is a faulty medium, to a medium Ej which is an alternative medium, in the information storage medium library array apparatus according to a second embodiment of the present invention.

FIG. 9 is a diagram showing a state of recording areas after copying data from a medium Ci which is a faulty medium, to a medium Ej which is an alternative medium, in the information storage medium library array apparatus according to the second embodiment of the present invention.

FIG. 10 is a diagram for describing a RAID 5 system.

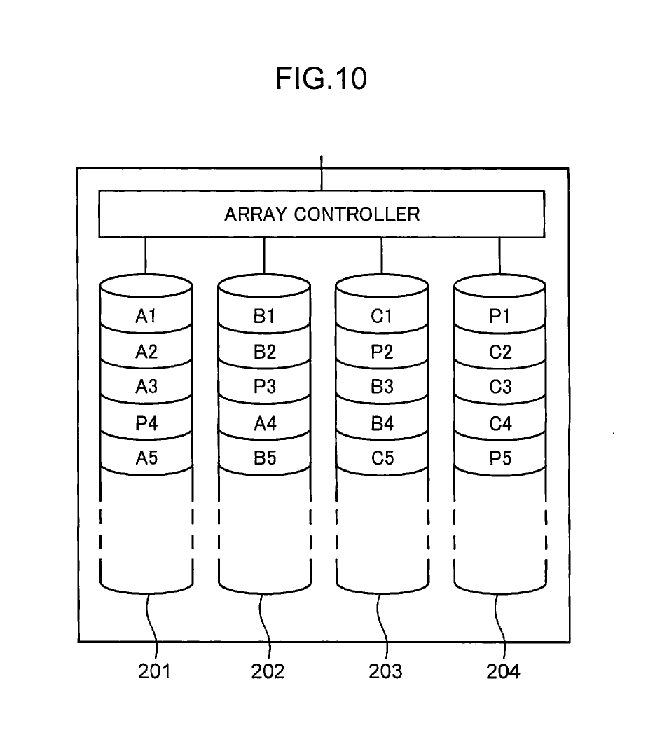

### DESCRIPTION OF EMBODIMENTS

Below, an embodiment of the present invention is described with reference to the drawings. The embodiment described below is one example of a concrete embodiment of the present invention, and is not intended to limit the technical scope of the present invention.

### First Embodiment

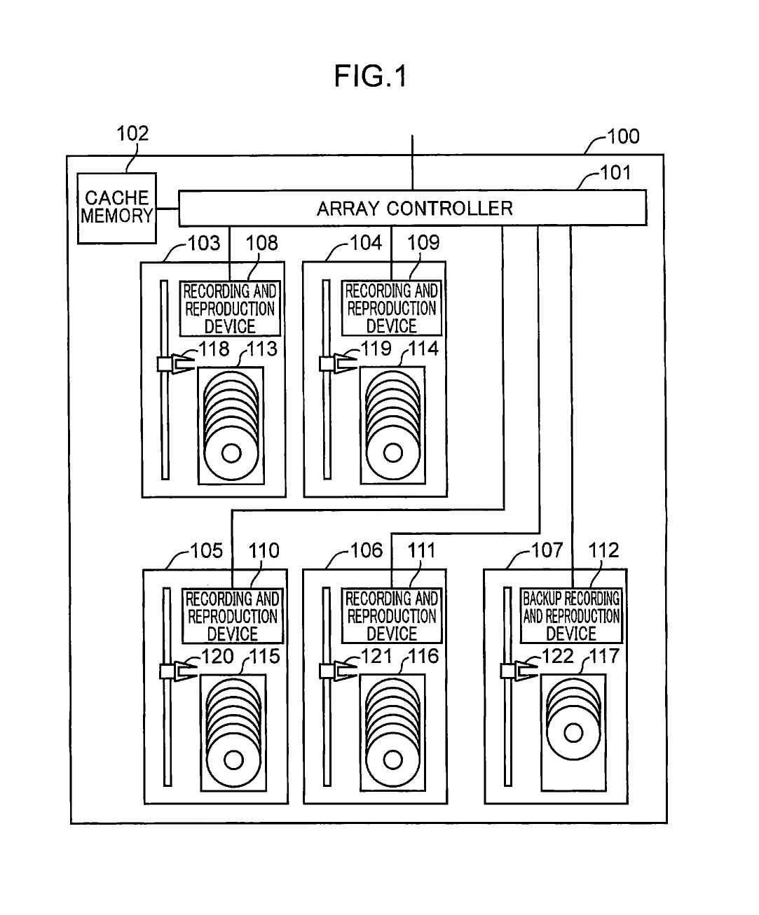

FIG. 1 is a drawing showing a composition of an information storage medium library array apparatus 100 according to a first embodiment of the present invention.

In FIG. 1, the information storage medium library array apparatus 100 includes an array controller 101, a cache memory 102, and information storage medium library apparatuses 103 to 107. The information storage medium library array apparatus 100 records data in a distributed fashion to a plurality of information storage media. Each information storage medium has a user area which records data, and the data is recorded continuously on tracks.

The array controller 101 is a controller which controls the information storage medium library apparatuses 103 to 107 so as to achieve an array configuration. The array controller 101 uses the cache memory 102 in order to temporarily hold data which has been read out from the information storage medium library apparatuses 103 to 107, and in order to temporarily hold data which is to be recorded to the information storage medium library apparatuses 103 to 107.

The cache memory 102 temporarily holds data which has been read out from the information storage medium library apparatuses 103 to 107, and temporarily holds data which is to be recorded on the information storage medium library apparatuses 103 to 107.

The information storage medium library apparatuses 103 to 107 respectively include recording and reproduction devices 108 to 111, a backup recording and reproduction device 112, accommodating bodies 113 to 117, and conveyance bodies 118 to 122. The recording and reproduction devices 108 to 111 reproduce data from a write-once information storage medium which has been installed therein, and record data to the write-once information storage medium. The backup recording and reproduction device 112 records data on a write-once information storage medium (alternative information storage medium) which is a substitute for one of the plurality of write-once information storage media, and reproduces data from the alternative information storage medium. The accommodating bodies 113 to 117 accommodate a plurality of write-once information storage media.

The conveyance bodies 118 to 121 convey the write-once information storage media between the recording and reproduction devices 108 to 111 and the accommodating bodies 113 to 116. The conveyance body 122 conveys the write-once information storage medium (alterative information storage medium) between the backup recording and reproduction device 112 and the accommodating body 117. The write-once information storage medium is a write-once information storage medium having a user area where user data is recorded, such as a BD-R medium. The write-once information storage medium records user data continuously on a track.

The array controller 101 controls the operation of the recording and reproduction devices 108 to 111 and the backup recording and reproduction device 112, and records data in a distributed fashion to information storage media installed in the recording and reproduction devices 108 to 111. The array controller 101 detects that a fault has occurred whereby an information storage medium installed in any of the recording and reproduction devices 108 to 111 has become unable to record data. The recording and reproduction devices 108 to 111 each record data to the information storage medium that is a recording object, of the plurality of information storage media. The backup recording and reproduction device 112 records alternatively data that ought to be recorded to a faulty information storage medium (also called “faulty medium” below) in which the occurrence of a fault has been detected by the array controller 101, to an alternative information storage medium (also called “alternative medium” below).

Furthermore, if the array controller 101 receives a reproduction request in relation to the faulty information storage medium and if the area designated by the reproduction request is a recorded area of the alternative information storage medium, then the array controller 101 reproduces data from the alternative information storage medium, and if the area designated by the reproduction request is an unrecorded area of the alternative information storage medium and a recorded area of the faulty information storage medium, then the array controller 101 reproduces data from the faulty information storage medium.

In the present embodiment, a disk array is constituted by four write-once information storage media which are installed respectively in the recording and reproduction devices 108 to 111 provided in the information storage medium library apparatuses 103 to 106. Furthermore, the plurality of write-once information storage media which are accommodated in the accommodating body 117 provided in the information storage medium library apparatus 107 are backup write-once information storage media, and form alternative information storage media which are an alternative destination when a fault has occurred whereby data cannot be recorded to a write-once information storage medium which is fitted in the recording and reproduction devices 108 to 111.

In the first embodiment, a disk array of any RAID level is constituted by four write-once information storage media which are installed in the recording and reproduction devices 108 to 111.

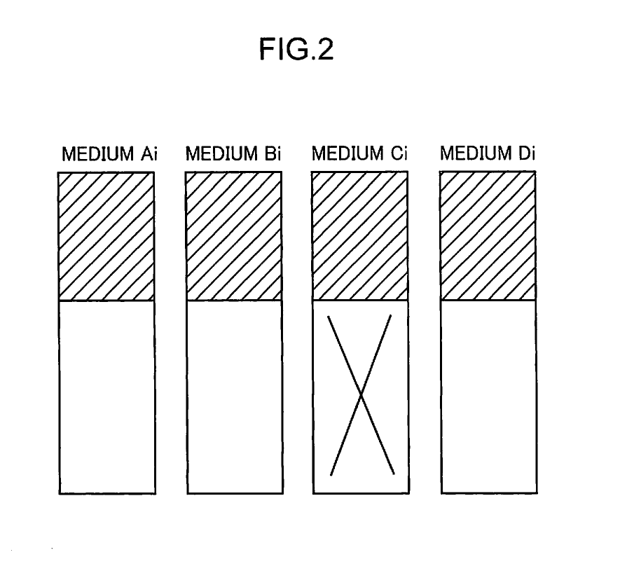

There follows a description of the operation that arises when the medium Ai, the medium Bi, the medium Ci and the medium Di, which are the write-once information storage media in the accommodating bodies 113 to 116, are installed respectively in the recording and reproduction devices 108 to 111, when a disk array is constituted by the medium Ai, the medium Bi, the medium Ci and the medium Di, and when the medium Ci is not able to perform recording, with reference to FIG. 2 to FIG. 4.

A write-once information storage medium becomes unable to perform recording when, for instance, the calibration of the recording power or the recording light emission waveform has not been completed correctly, due to factors such as deterioration of the write-once information storage medium over time, and so on. If the write-once information storage medium is not able to perform recording, then although data cannot be recorded to the write-once information storage medium, data can be reproduced from an area of the write-once information storage medium which has already been recorded. Below, a write-once information storage medium which is not able to perform recording is called a faulty information storage medium or a faulty medium.

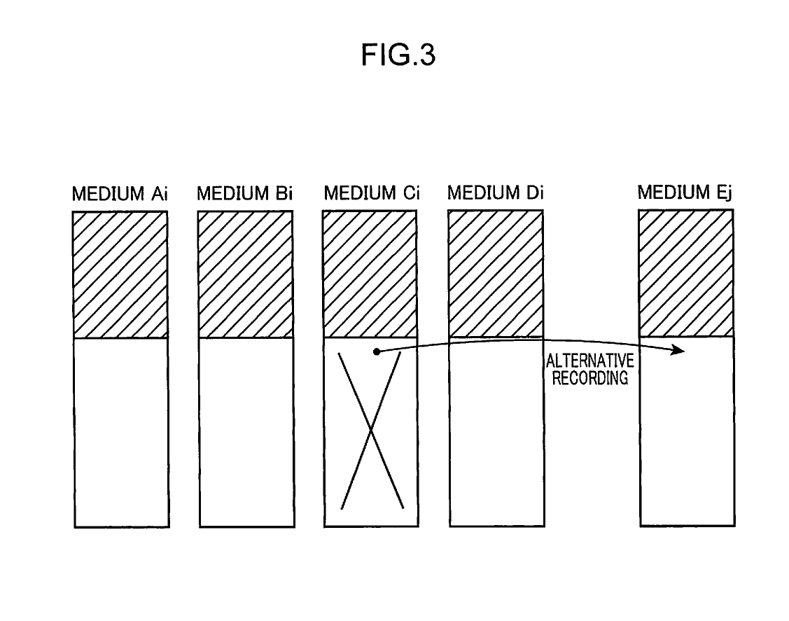

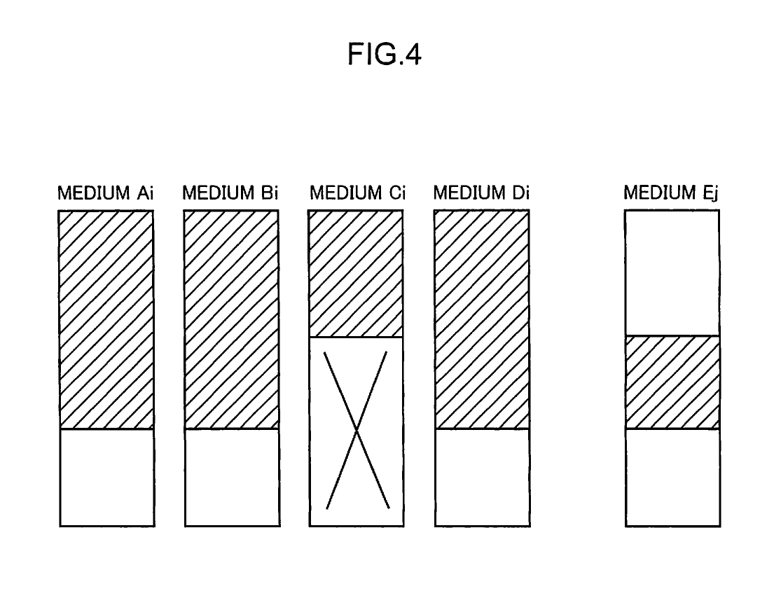

FIG. 2 is a diagram showing one example of a state of the recording areas of the medium Ai, the medium Bi, the medium Ci and the medium Di, when the medium Ci has become unable to perform recording during an operation. FIG. 3 is a diagram showing one example of the state of the recording areas of the medium Ai, the medium Bi, the medium Ci, the medium Di and the medium Ej, when the medium Ej is installed in a backup recording and reproduction device. FIG. 4 is a diagram showing one example of the state of the recording areas of the medium Ai, the medium Bi, the medium Ci, the medium Di and the medium Ej, when data that ought to be recorded to the medium Ci is recorded alternatively to the medium Ej. In FIG. 2 to FIG. 4, the hatched areas indicate recorded areas.

As shown in FIG. 2, data has been recorded partway in the recording areas of the medium Ai, the medium Bi, the medium Ci and the medium Di. In FIG. 3, the conveyance body 122 installs the medium Ej, which is an unused write-once information storage medium stored in the accommodating body 117, in the backup recording and reproduction device 112. As shown in FIG. 4, the data that was scheduled to be recorded to the medium Ci by the recording and reproduction device 110 is recorded alternatively to the medium Ej by the backup recording and reproduction device 112. In this case, the recording position of the data which is recorded alternatively to the medium Ej is the same as the recording position that was scheduled for recording to the medium Ci.

In a write-once information storage medium, the next writable position is limited. Therefore, normally, when data is initially recorded alternatively to the medium Ej, the recording position on the medium Ej which is the same as the recording position that was scheduled for recording to the medium Ci is not a next writable position. In this case, it is necessary to reserve a track and to set a next writable position, by means of a RESERVE TRACK command. Hereinafter, the medium Ej corresponds to an alternative medium for the medium Ci which is a faulty medium.

In the state shown in FIG. 4, if the array controller 101 has received a data reproduction request in relation to the medium Ci and if the area to be reproduced is a recorded area of the medium Ej, which is the alternative medium, then the array controller 101 reproduces data from the medium Ej, and if the area to be reproduced is an unrecorded area of the medium Ej, then the array controller 101 reproduces data from the medium Ci. When data is reproduced from the medium Ci, the array controller 101 also stores the reproduced data in the cache memory 102.

The array controller 101 of the information storage medium library array apparatus 100 shown in FIG. 1 is typically achieved by a program which is processed in coordinated fashion by a processor and an external memory.

In the present embodiment, the information storage medium library array apparatus 100 corresponds to one example of an information storage medium library array apparatus, the recording and reproduction devices 108 to 111 correspond to one example of a plurality of recording and reproduction devices, the backup recording and reproduction device 112 corresponds to one example of a backup recording and reproduction device, the array controller 101 corresponds to one example of a control unit, a recording control unit, a fault occurrence detection unit and an alternative recording control unit, and the cache memory 102 corresponds to one example of a cache memory.

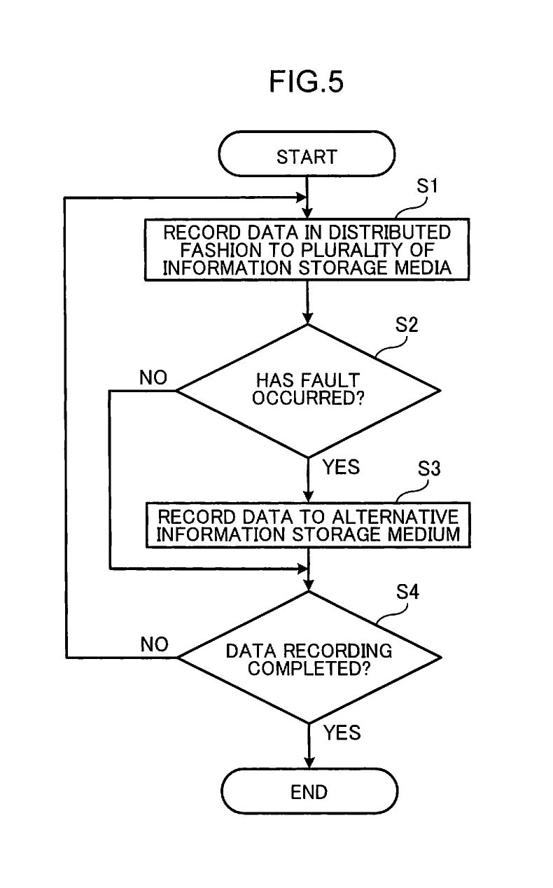

FIG. 5 is a flowchart showing one example of a recording operation of information storage medium library array apparatus according to the first embodiment of the present invention.

Firstly, in step S1, the array controller 101 divides input data into a plurality of data, and controls the conveyance bodies 118 to 121 and the recording and reproduction devices 108 to 111 so as to record the respective data in a distributed fashion to the information storage media accommodated in the accommodating bodies 113 to 116. In this case, the array controller 101 divides the data in accordance with the RAID level, and if necessary, creates parity data from the divided data.

The conveyance bodies 118 to 121 take out the information storage media, respectively, from the accommodating bodies 113 to 116, and install the information storage media in the recording and reproduction devices 108 to 111, on the basis of an instruction from the array controller 101. In this case, a memory (not illustrated) stores management data for managing all of the information storage media accommodated in the accommodating bodies 113 to 117. The management data includes information for identifying a combination of a plurality of information storage media which constitute a disk array, information for identifying a faulty information storage medium, and information for identifying an alternative information storage medium which is a substitute for the faulty information storage medium. The management data may include information indicating whether or not all of the data of the faulty information storage medium is recorded in the alternative information storage medium.

Moreover, the management data may include information which associates data with a plurality of information storage media which record a plurality of data obtained by dividing up the data, and information indicating a position where the data of each information storage medium is recorded. The array controller 101 may associate the input data and the plurality of information storage media which record the input data in a distributed fashion, and store this association in a memory which is not illustrated, and the array controller 101 may store the recording positions of the data in the respective information storage media, in a memory which is not illustrated.

The recording and reproduction devices 108 to 111 record data output from the array controller 101, to the prescribed positions of the information storage media, on the basis of instructions from the array controller 101.

Next, in step S2, the array controller 101 judges whether or not a fault has occurred whereby an information storage medium fitted to any one of the recording and reproduction devices 108 to 111 has become unable to record data. The array controller 101 detects that a fault has occurred whereby an information storage medium installed in any of the recording and reproduction devices 108 to 111 has become unable to record data.

The array controller 101 judges that recording is not possible when a recording operation cannot be completed correctly and an error is reported from a recording and reproduction device. Furthermore, if the write-once information storage medium has a spare area and alternative recording to the spare area is successful, then the recording and reproduction device does not report an error. Therefore, if alternative recording to the spare area of the information storage medium is successful, then the array controller 101 does not judge that recording is not possible. Factors that make recording impossible are: deterioration of the information storage medium over time, deterioration of the laser light source of the recording and reproduction device, and unsuccessful calibration of the recording power or the recording light emission waveform. A state where recording is impossible is called a faulty state, and consequently, an information storage medium which cannot record data is called a faulty information storage medium or a faulty medium.

Here, if it is judged that a fault has not occurred (NO at step S2), then the procedure transfers to the processing in step S4.

On the other hand, if it is judged that a fault has occurred (YES at step S2), then in step S3, the array controller 101 controls the conveyance body 122 and the backup recording and reproduction device 112 in such a manner that data that ought to be recorded to the faulty information storage medium in which the occurrence of a fault has been detected is recorded alternatively to the alternative information storage medium. The conveyance body 122 takes out the alternative information storage media from the accommodating body 117, and installs this alternative information storage media in the backup recording and reproduction device 112, on the basis of an instruction from the array controller 101. In this case, the array controller 101 associates the faulty information storage medium in which the occurrence of a fault has been detected, and the alternative information storage medium to which the data that ought to be recorded to the faulty information storage medium is recorded alternatively, and stores this association in a memory which is not illustrated, and stores the recording position of the data in the alternative information storage medium in a memory which is not illustrated.

The backup recording and reproduction device 112 records data that ought to be recorded on the faulty information storage medium in which the occurrence of a fault has been detected, to a prescribed position on the alternative information storage medium, on the basis of an instruction from the array controller 101.

Next, in step S4, the array controller 101 judges whether or not all of the input data has been recorded to an information storage medium. Here, if it is judged that all of the input data has been recorded to an information storage medium (YES at step S4), then the array controller 101 terminates the recording operation. On the other hand, if it is judged that all of the input data has not been recorded to an information storage medium (NO at step S4), then the procedure returns to the processing in step Si and the array controller 101 continues the recording operation.

Next, the recording operation and the reproduction operation by the information storage medium library array apparatus 100 in the first embodiment will also be described.

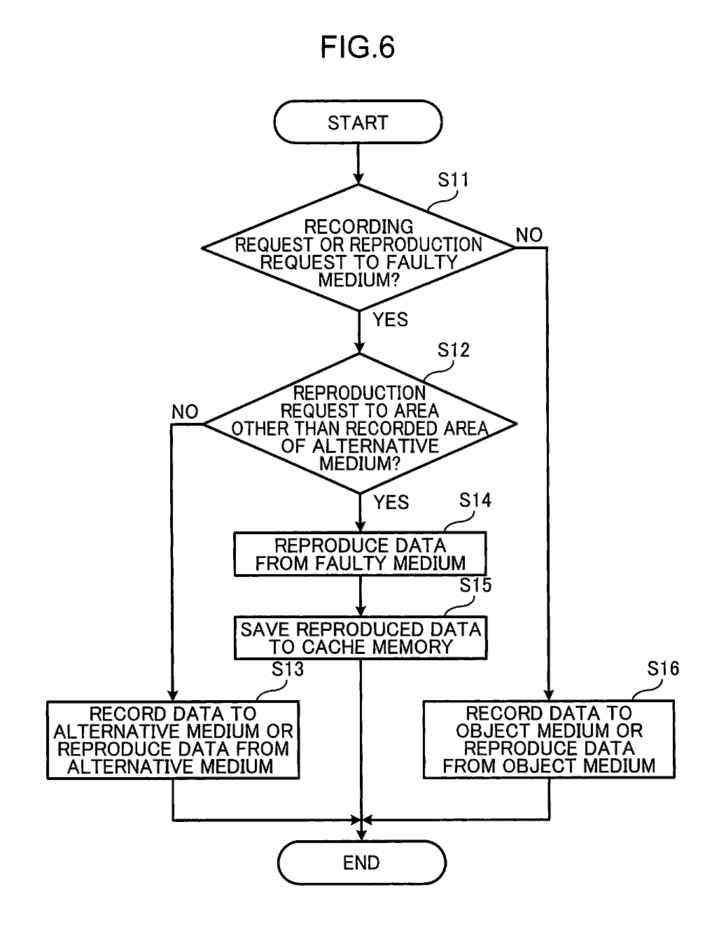

FIG. 6 is a flowchart showing a recording operation or a reproduction operation in relation to a recording request or a reproduction request in the information storage medium library array apparatus 100 according to the first embodiment of the present invention.

Firstly, in step S11, the array controller 101 receives a recording request or a reproduction request from an external source, and judges whether or not the recording request or reproduction request relates to a faulty medium. Here, if it is judged that the recording request or the reproduction request is not related to a faulty medium (NO at step S11), then in step S16, the array controller 101 controls the conveyance bodies 118 to 121 and the recording and reproduction devices 108 to 111 so as to record data to the information storage medium (object medium) which is the object of the recording request, or so as to reproduce data from the information storage medium which is the object of the reproduction request, and then terminates processing.

On the other hand, if it is judged that the recording request or the reproduction request relates to a faulty medium (YES at step S11), then in step S12, the array controller 101 judges whether or not the request is a reproduction request to an area other than a recorded area of the alternative medium corresponding to the faulty medium. Here, if it is judged that the request is a recording request to a faulty medium or if it is judged that the request is a reproduction request to a recorded area of the alternative medium corresponding to a faulty medium (NO at step S12), then in step S13, the array controller 101 controls the conveyance body 122 and the backup recording and reproduction device 112 so as to record data to the alternative medium corresponding to the faulty medium or so as to reproduce data from the alternative medium corresponding to the faulty medium, and then terminates processing.

On the other hand, if it is judged that the request is a reproduction request to an area other than a recorded area of the alternative medium corresponding to the faulty medium (YES at step S12), then in step S14, the array controller 101 controls the conveyance bodies and the recording and reproduction devices so as to reproduce data from the faulty medium.

Next, in step S15, the array controller 101 saves the data reproduced from the faulty medium, to the cache memory 102, and terminates processing.

In this way, even if it is detected that a write-once information storage medium has entered a state of not being able to record data, it is still possible to record or reproduce data continuously, without carrying out a recovery operation of the information storage medium.

There are restrictions on the recording positions where data can be recorded to a write-once information storage medium. Therefore, when a recording request is made to a position other than a next writable position, the array controller 101 may terminate with an error. Furthermore, if a reproduction position from which reproduction has been requested is an unrecorded area, then the array controller 101 may terminate with an error.

For example, in order to process a recording request or a reproduction request relating to the medium Ci in FIG. 2, the array controller 101 must control the information storage medium library apparatus 105 and the information storage medium library apparatus 107 and access the medium Ci and the medium Ej. Therefore, in this case, the operational efficiency declines. Therefore, desirably, the array controller 101 copies the data of the recorded area of the medium Ci to the medium Ej, and hence controls the information storage medium library apparatus 107 only and either records data to the medium Ej only, or reproduces data from the medium Ej only.

The array controller 101 copies all of the data in the recorded user area of the faulty information storage medium, to the alternative information storage medium, and when there is a recording request or a reproduction request in relation to the faulty information storage medium of which all of the data has been copied, the array controller 101 controls the backup recording and reproduction device 112 so as to use the alternative information storage medium.

Furthermore, if the area designated by the reproduction request is an unrecorded area of the alternative information storage medium and is a recorded area of a faulty information storage medium, then the array controller 101 reproduces data from the faulty information storage medium and also stores the reproduced data in the cache memory 102. When copying all of the data of the recorded user area of the faulty information storage medium, to the alternative information storage medium, the array controller 101 copies the data that has been stored in the cache memory 102, among all of the data, from the cache memory 102 to the alternative information storage medium.

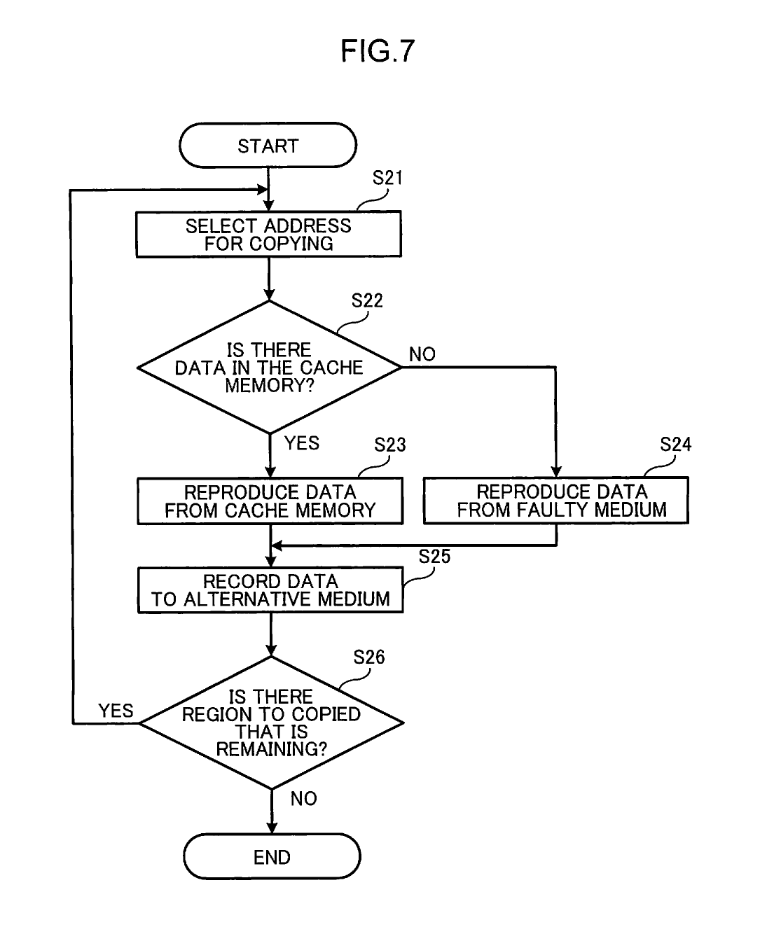

FIG. 7 is a flowchart for describing a process of copying from a faulty medium to an alternative medium in an information storage medium library array apparatus 100 according to the first embodiment of the present invention.

Firstly, in step S21, the array controller 101 selects an address for copying from the faulty medium to the alternative medium. The array controller 101 selects the smallest address of the area to be copied from the faulty medium to the alternative medium, as the address for copying.

Next, in step S22, the array controller 101 judges whether or not the data at the address of the faulty medium selected in step S21 has been stored in the cache memory 102. Here, if the array controller 101 judges that the data at the address to be copied has been stored in the cache memory 102 (YES at step S22), then in step S23, the array controller 101 reproduces the data corresponding to the address of the faulty medium selected in step S21, from the cache memory 102.

On the other hand, if the array controller 101 judges that the data at the address to be copied has not been stored in the cache memory 102 (NO at step S22), then in step S24, the array controller 101 controls the conveyance bodies and the recording and reproduction devices so as to reproduce the data at the address of the faulty medium selected in step S21.

Thereupon, in step S25, the array controller 101 controls the conveyance body 122 and the backup recording and reproduction device 112 so as to record the data reproduced in step S23 or step S24, to the alternative medium.

Thereupon, in the step S26, the array controller 101 judges whether or not there remains an area that ought to be copied from the faulty medium to the alternative medium. An area that ought to be copied from the faulty medium to the alternative medium is an area which has not been copied to the alternative medium, of the recorded area in the user area of the faulty medium. Here, if it is judged that there remains an area that ought to be copied from the faulty medium to the alternative medium (YES at step S26), then the procedure returns to the processing in step S21, and the array controller 101 repeats the processing from step S21 to step S26 until there is no longer any area to be copied from the faulty medium to the alternative medium.

On the other hand, if all of the data of the area to be copied from the faulty medium to the alternative medium has been copied and it is judged that there remains no area that ought to be copied from the faulty medium to the alternative medium (NO at step S26), then the array controller 101 terminates the copying process.

In step S24, if data cannot be reproduced immediately from the faulty medium, for instance, if recording requests or reproduction requests to the information storage medium library array apparatus 100 continue endlessly, or if the faulty medium is not installed in any of the recording and reproduction devices 108 to 111, then the array controller 101 may pause the data reproduction processing from the faulty medium, until there is a break in the recording requests or reproduction requests to the information storage medium library array apparatus 100 and sufficient free time can be ensured. When sufficient free time has been ensured, if the faulty medium is not installed in any of the recording and reproduction devices 108 to 111, then the array controller 101 may install the faulty medium in one of the recording and reproduction devices 108 to 111 and continue the processing from step S24 onwards.

Furthermore, the array controller 101 may discard the data from the cache memory 102 after the data reproduced from the cache memory 102 in step S23 has been recorded to the alternative medium in step S25.

Furthermore, in step S15 in FIG. 6, the array controller 101 saves the data reproduced from the faulty medium, to the cache memory 102. By this means, even if the faulty medium is not installed in the recording and reproduction devices 108 to 111, it is possible to copy the data which has been saved in the cache memory 102, to the alternative medium. Therefore, it is possible to carry out a copying process without affecting recording requests or reproduction requests relating to the information storage medium library array apparatus 100.

When all of the data of the recorded area of the faulty medium has been copied to the alternative medium, then the faulty medium becomes unnecessary thereafter. Consequently, the array controller 101 may install the alternative medium, instead of the faulty medium, in the backup recording and reproduction device 112, and may record or reproduce data to and from the alternative medium, instead of the faulty medium. Furthermore, the array controller 101 may install the alternative medium, instead of the faulty medium, in any one of the information storage medium library apparatuses 103 to 106.

The first embodiment can be implemented for any RAID level including RAID 0 which performs striping only and does not require redundancy in the constructed disk array.

### Second Embodiment

In a second embodiment, RAID 5 is constructed by four write-once information storage media which are installed in the recording and reproduction devices 108 to 111. Consequently, even if data cannot be reproduced from one of the write-once information storage media installed in the recording and reproduction devices 108 to 111, restoration of the data is possible.

The information storage medium library array apparatus according to the second embodiment is similar to that of the first embodiment, apart from the operation for copying the data of the recorded area of the faulty medium, to the alternative medium. Therefore, the description below relates only to the operation for copying the data of the recorded area of the faulty medium, to the alternative medium.

The plurality of information storage media constituting the disk array have redundancy which enables restoration of data from another information storage medium, even if at least one of the information storage media which constitute the disk array cannot reproduce data.

Upon receiving a reproduction request for the disk array which is constituted by a plurality of information storage media of which all of the user areas have been recorded, the array controller 101 substitutes one of the plurality of information storage media for a faulty information storage medium, and copies all of the data of the recorded user area of the faulty information storage medium, to this alternative information storage medium, and restores the data of the information storage medium which has been substituted for the faulty information storage medium, on the basis of data reproduced from the remaining information storage media.

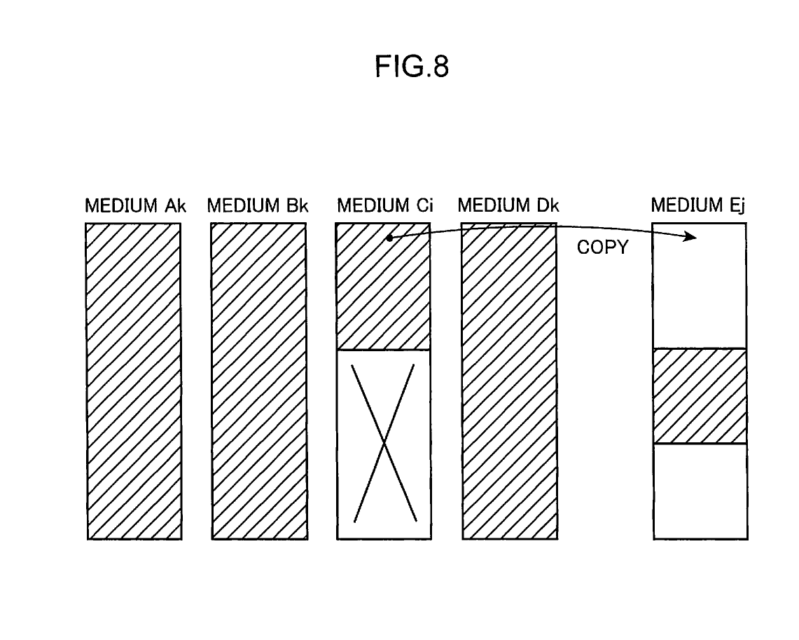

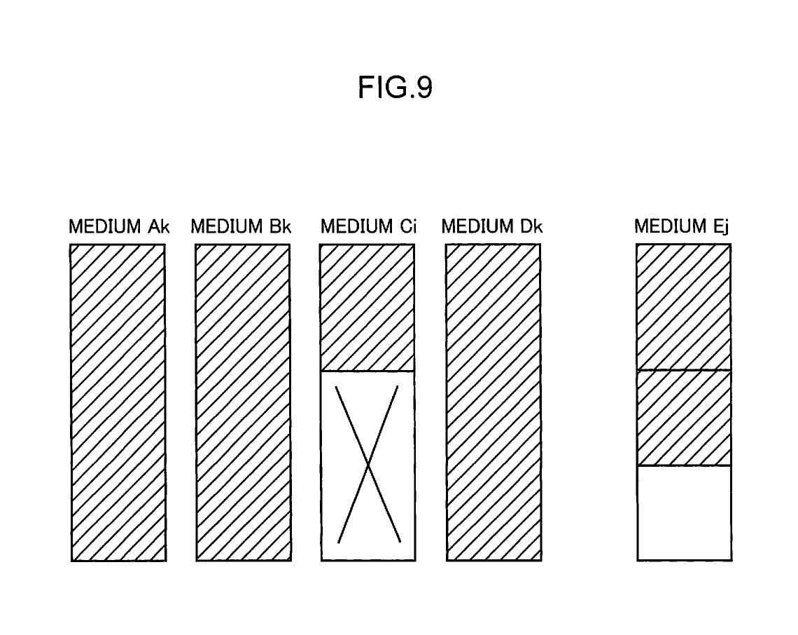

FIG. 8 and FIG. 9 are diagrams for illustrating a copying process for copying data from a medium Ci which is a faulty medium in the information storage medium library array apparatus 100 according to the second embodiment of the present invention, to a medium Ej which is an alternative medium. FIG. 8 is a diagram showing a state of a recording area before copying data from the medium Ci which is a faulty medium, to the medium Ej which is an alternative medium, in the information storage medium library array apparatus 100 according to the second embodiment of the present invention; and FIG. 9 is a diagram showing a state of a recording area after copying data from the medium Ci which is a faulty medium to the medium Ej which is an alternative medium, in the information storage medium library array apparatus 100 according to the second embodiment of the present invention. In FIG. 8 and FIG. 9, the hatched areas indicate recorded areas.

Upon receiving a reproduction request to a set of write-once information storage media consisting of a medium Ak, a medium Bk, a medium Ck and a medium Dk, in which the user areas for recording user data have all been recorded, as shown in FIG. 8, the array controller 101 of the information storage medium library array apparatus 100 installs the medium Ak in the recording and reproduction device 108, installs the medium Bk in the recording and reproduction device 109, installs the medium Ci, which is a faulty medium, in the recording and reproduction device 110, installs the medium Dk in the recording and reproduction device 111, and installs the medium Ej, which is the alternative medium, in the backup recording and reproduction device 112. Data is recorded partway in the recording area (user area) of the medium Ci. On the medium Ej, data is recorded from the same position as the position where recording become impossible on the medium Ci.

In the state shown in FIG. 8, the array controller 101 successively copies the data of the area of the medium Ci for which copying has not been completed, to the medium Ej. If the array controller 101 receives a reproduction request in respect of data recorded on a medium Ck, during the copying operation from the medium Ci to the medium Ej, the array controller 101 restores and returns the data on the medium Ck, on the basis of the respective data on the medium Ak, medium Bk and medium Dk. In the second embodiment, a RAID 5 is constructed by the medium Ak, the medium Bk, the medium Ck and the medium Dk. Therefore, when restoring the data on the medium Ck, the array controller 101 should calculate an exclusive OR operation of the data at the same position as the medium Ck, on the medium Ak, the medium Bk and the medium Dk.

As shown in FIG. 9, when the copying of data from the medium Ci to the medium Ej has been completed, the medium Ci, which is a faulty medium, subsequently becomes unnecessary, and therefore the medium Ej, which is the alternative medium, is used instead of the medium Ci.

In this way, it is possible to carry out data reproduction by restoration of data in a RAID, while causing virtually no decline in performance. Consequently, there is hardly any decline in performance, even if, as in the second embodiment, data is copied from a faulty medium to an alternative medium using a recording and reproduction device which is no longer required to reproduce data, while restoring data within the range of redundancy of the RAID, when reproducing data from a set of write-once information storage media which cannot record further data in the user areas, due to user data having been recorded to all of the user areas.

In the second embodiment, a disk array is constituted as RAID 5, but the invention may also be applied similarly to other RAID levels, provided that they have redundancy which allows data to be restored, even if at least one of the write-once information storage media constituting a disk array cannot reproduce data. For example, the invention can also be applied similarly to a disk array constituted as RAID 6.

In the present embodiment, an example is described in which a disk array is constituted by four write-once information storage media which are installed in recording and reproduction devices 108 to 111 that are provided in information storage medium library apparatuses 103 to 106, but the present invention is not limited to this. The present invention can also be implemented in a similar fashion to the first and second embodiments, in the case of a disk array which is constituted by a plurality of write-once information storage media. For instance, a disk array may be constituted by five write-once information storage media. Furthermore, desirably, to ensure redundancy, a disk array is constituted by at least three information storage media.

In a general recording and reproduction device, if a DVD-R, or the like, is used as a write-once information storage medium, and if a track is reserved by a RESERVE TRACK command, then a linking loss area where user data cannot be recorded may be created, and the same data as the faulty medium may not be write-once on the alternative medium. Therefore, by using a special recording and reproduction device which is designed so as not to create a linking loss area, the invention can also be applied to write-once information storage media such as DVD-R media.

The concrete embodiments described above principally include an invention having the following composition.

The information storage medium library array apparatus relating to one aspect of the present invention is an information storage medium library array apparatus which records data to a plurality of information storage media and an alternative information storage medium which is a substitute for one of the plurality of information storage media, wherein each of the plurality of information storage media and the alternative information storage medium record data continuously on tracks, the information storage medium library array apparatus comprising: a plurality of recording and reproduction devices which record data to the information storage media and also reproduce data from the information storage media; a backup recording and reproduction device which records data to the alternative information storage media and also reproduces data from the alternative information storage media; and a control unit which controls operations of the plurality of recording and reproduction devices and the backup recording and reproduction device, and controls the plurality of recording and reproduction devices so as to record the data, in a distributed fashion, to the plurality of information storage media, wherein the plurality of recording and reproduction devices each record the data to the information storage medium that is a recording object, of the plurality of information storage media; the information storage media installed respectively in the plurality of recording and reproduction devices constitute a disk array; the control unit detects that a fault has occurred in which the information storage medium installed in any one of the plurality of recording and reproduction devices has become unable to perform recording; and the backup recording and reproduction device alternatively records to the alternative information storage medium data that ought to be recorded to a faulty information storage medium in which the occurrence of a fault has been detected by the control unit.

According to this composition, each of the plurality of information storage media and the alternative information storage medium record data continuously on tracks. The plurality of recording and reproduction devices record data to the information storage media and also reproduce data from the information storage media. The backup recording and reproduction device records data to the alternative information storage medium and also reproduces data from the alternative information storage medium. The control unit controls the plurality of recording and reproduction devices and the backup recording and reproduction device, and controls operations of the plurality of recording and reproduction devices so as to record the data in a distributed fashion on the plurality of information storage media. The plurality of recording and reproduction devices each record the data to the information storage medium that is a recording object, of the plurality of information storage media. Each of the information storage media installed respectively in the plurality of recording and reproduction devices constitute a disk array. The control unit detects that a fault has occurred where the information storage medium installed in any one of the plurality of recording and reproduction devices has become unable to perform recording. The backup recording and reproduction device alternatively records data that ought to be recorded to a faulty information storage medium in which the occurrence of a fault has been detected by the control unit, to the alternative information storage medium.

Consequently, since the data that ought to be recorded to a faulty information storage medium in which the occurrence of a fault has been detected is recorded alternatively to the alternative information storage medium, then it is possible to continue recording and reproduction readily, without decline in performance, even if an information storage medium constituting the disk array has become unable to perform recording.

Furthermore, desirably, in the information storage medium library array apparatus described above, each of the plurality of information storage media and the alternative information storage medium are write-once information storage media.

According to this composition, since each of the plurality of information storage media and the alternative information storage medium are write-once information storage media, then it is possible to construct a disk array by write-once information storage media, rather than rewriteable information storage media.

Furthermore, in the information storage medium library array apparatus described above, desirably, when the control unit receives a reproduction request in relation to the faulty information storage medium and when an area designated by the reproduction request is a recorded area of the alternative information storage medium, then the control unit reproduces data from the alternative information storage medium, and when the area designated by the reproduction request is an unrecorded area of the alternative information storage medium and is a recorded area of the faulty information storage medium, then the control unit reproduces data from the faulty information storage medium.

According to this composition, if the control unit receives a reproduction request in relation to a faulty information storage medium and if the area designated by the reproduction request is a recorded area of an alternative information storage medium, then the control unit reproduces data from the alternative information storage medium. Furthermore, if the area designated by the reproduction request is an unrecorded area of the alternative information storage medium and is a recorded area of the faulty information storage medium, then the control unit reproduces data from the faulty information storage medium.

Therefore, if the area designated by the reproduction request is a recorded area of an alternative information storage medium, then data is reproduced from the alternative information storage medium and if the area designated by the reproduction request is an unrecorded area of the alternative information storage medium and is a recorded area of the faulty information storage medium, then data is reproduced from the faulty information storage medium, thereby making it possible to reproduce data from either one of the alternative information storage medium and the faulty information storage medium.

Furthermore, in the information storage medium library array apparatus described above, desirably, each of the plurality of information storage media has a user area where the data is recorded; and the control unit copies all of the data in the recorded user area of the faulty information storage medium, to the alternative information storage medium, and when there is a recording request or a reproduction request in relation to the faulty information storage medium, all the data of which has been copied, the control unit controls the backup recording and reproduction device so as to use the alternative information storage medium.

According to this composition, each of the plurality of information storage media has a user area which records data. The control unit copies all of the data of the recorded user area of the faulty information storage medium, to the alternative information storage medium. The control unit then controls the backup recording and reproduction device so as to use the alternative information storage medium, when there is a recording request or a reproduction request in relation to the faulty information storage medium of which all of the data has been copied.

Consequently, all of the data in the recorded user area of the faulty information storage medium is copied to the alternative information storage medium, and if there is a recording request or a reproduction request in relation to a faulty information storage medium of which all of the data has been copied, then the alternative information storage medium is used, which means that data can be recorded or reproduced readily, by accessing the alternative information storage medium only and without accessing the faulty information storage medium.

Furthermore, desirably, the information storage medium library array apparatus described above further comprises: a cache memory; and when an area designated by the reproduction request is an unrecorded area of the alternative information storage medium and is a recorded area of the faulty information storage medium, then the control unit reproduces data from the faulty information storage medium and also stores the reproduced data in the cache memory; and when copying all of the data of the recorded user area of the faulty information storage medium, to the alternative information storage medium, the control unit copies the data that has been stored in the cache memory, among all of the data, from the cache memory to the alternative information storage medium.

According to this composition, if the region designated by the reproduction request is an unrecorded area of the alternative information storage medium and is a recorded area of a faulty information storage medium, then the control unit reproduces data from the faulty information storage medium and also stores the reproduced data in the cache memory. Furthermore, when copying all of the data of the recorded user area of the faulty information storage medium, to the alternative information storage medium, the control unit copies the data that has been stored in the cache memory, among all of the data, from the cache memory to the alternative information storage medium.

Therefore, since the data reproduced from the faulty information storage medium is stored in the cache memory and the data that has been stored in the cache memory, among all of the data, is copied to the alternative information storage medium from the cache memory, then it is possible to copy data from the cache memory to the alternative information storage medium, even if the faulty information storage medium is not installed in a recording and reproduction device.

Furthermore, desirably, in the information storage medium library array apparatus described above, each of the plurality of information storage media has a user area where the data is recorded; the plurality of information storage media have redundancy which enables restoration of data from another information storage medium, even if at least one of the information storage media which constitute the disk array cannot reproduce data; and when the control unit receives a reproduction request for the disk array which is constituted by the plurality of information storage media, all the user of which areas have been recorded, the control unit substitutes any of the plurality of information storage media for the faulty information storage medium, copies all of the data of the recorded user area of the faulty information storage medium, to the alternative information storage medium, and restores the data of the information storage medium which has been substituted for the faulty information storage medium, on the basis of data reproduced from the remaining information storage media.

According to this composition, each of the plurality of information storage media has a user area which records data. The plurality of information storage media have redundancy which enables restoration of data from another information storage medium, even if at least one of the information storage media which constitute the disk array cannot reproduce data. Upon receiving a reproduction request for the disk array which is constituted by a plurality of information storage media of which all of the user areas have been recorded, the control unit substitutes one of the plurality of information storage media for the faulty information storage medium, and copies all of the data of the recorded user area of the faulty information storage medium, to the alternative information storage medium, and restores the data of the information storage medium which has been substituted for the faulty information storage medium, on the basis of data reproduced from the remaining information storage media.

Consequently, data that is recorded on the information storage medium that has been substituted for the faulty information storage medium can be restored on the basis of data reproduced from information storage media other than the information storage medium substituted for the faulty information storage medium, without reproducing data from the information storage medium substituted for the faulty information storage medium, and hence data can be copied from the faulty information storage medium to the alternative information storage medium while restoring the data that is recorded on the information storage medium substituted for the faulty information storage medium.

The information recording method relating to a further aspect of the present invention is an information recording method for recording data to a plurality of information storage media and an alternative information storage medium which is a substitute for one of the plurality of information storage media, wherein each of the plurality of information storage media and the alternative information storage medium record data continuously on tracks, this information recording method comprising: a recording step of recording the data to the information storage medium that is a recording object, of the plurality of information storage media; a fault occurrence detection step of detecting that a fault has occurred in which the information storage medium installed in any one of the plurality of recording and reproduction devices has become unable to perform recording; and an alternative recording step of alternatively recording data that ought to be recorded to a faulty information storage medium in which the occurrence of a fault has been detected in the fault occurrence detection step, to the alternative information storage medium.

According to this composition, each of the plurality of information storage media and the alternative information storage medium record data continuously on tracks. In the recording step, data is recorded to the information storage medium that is a recording object, of the plurality of information storage media. In the fault occurrence detection step, it is detected that a fault has occurred where the information storage medium installed in any one of the plurality of recording and reproduction devices has become unable to perform recording. In the alternative recording step, the backup recording and reproduction device alternatively records data that ought to be recorded to a faulty information storage medium in which the occurrence of a fault has been detected by the fault occurrence detection step, to the alternative information storage medium.

Consequently, since the data that ought to be recorded to a faulty information storage medium in which the occurrence of a fault has been detected is recorded alternatively to the alternative information storage medium, then it is possible to continue recording and reproduction readily, without decline in performance, even if an information storage medium constituting the disk array has become unable to perform recording.

The information recording program relating to yet a further aspect of the present invention is an information recording program for recording data to a plurality of information storage media and an alternative information storage medium which is a substitute for one of the plurality of information storage media, wherein each of the plurality of information storage media and the alternative information storage medium record data continuously on tracks, this information recording program causing a computer to function as: a recording control unit which controls a plurality of recording and reproduction devices so as to record the data to the information storage medium that is a recording object, of the plurality of information storage media; a fault occurrence detection unit which detects that a fault has occurred in which the information storage medium installed in any of the plurality of recording and reproduction devices has become unable to perform recording; and an alternative recording unit which controls a backup recording and reproduction device so as to alternatively record data that ought to be recorded to a faulty information storage medium in which the occurrence of a fault has been detected by the fault occurrence detection unit, to the alternative information storage medium.

According to this composition, each of the plurality of information storage media and the alternative information storage medium record data continuously on tracks. The recording control unit which controls a plurality of recording and reproduction devices so as to record the data to the information storage medium that is a recording object, of the plurality of information storage media. The fault occurrence detection unit detects that a fault has occurred where the information storage medium installed in any one of the plurality of recording and reproduction devices has become unable to perform recording. The alternative recording control unit controls the backup recording and reproduction device so as to alternatively record data that ought to be recorded to a faulty information storage medium in which the occurrence of a fault has been detected by the control unit, to the alternative information storage medium.

Consequently, since the data that ought to be recorded to a faulty information storage medium in which the occurrence of a fault has been detected is recorded alternatively to the alternative information storage medium, then it is possible to continue recording and reproduction readily, without decline in performance, even if an information storage medium constituting the disk array has become unable to perform recording.

The concrete embodiments or practical examples which have been described in Description of Embodiments relating to the embodiments of the invention are merely intended to clarify the technical details of the present invention, and the invention should not be interpreted narrowly as being restricted to these concrete examples only, but rather can be implemented with various modifications within the spirit of the invention and the scope of the claims.

### INDUSTRIAL APPLICABILITY

The information storage medium library array apparatus, the information recording method and the information recording program relating to the present invention are useful as an information storage medium library array apparatus, an information recording method and an information recording program, whereby data is recorded in a distributed fashion to a plurality of information storage media and recording and reproduction can be continued readily without a decline in performance, even if an information storage medium which constitutes a disk array has become unable to perform recording. Furthermore, the information storage medium library array apparatus relating to the present invention can be applied to an archiving apparatus in a computer system, for example.

1-8. (canceled)

9. An information storage medium library array apparatus which records data to a plurality of write-once information storage media and a write-once alternative information storage medium which is a substitute for one of the plurality of write-once information storage media, wherein
each of the plurality of write-once information storage media and the write-once alternative information storage medium record data continuously on tracks,
the information storage medium library array apparatus comprising:
a plurality of recording and reproduction devices which record data to the write-once information storage media and also reproduce data from the write-once information storage media;
a backup recording and reproduction device which records data to the write-once alternative information storage media and also reproduces data from the write-once alternative information storage media; and
a control unit which controls operations of the plurality of recording and reproduction devices and the backup recording and reproduction device, and controls the plurality of recording and reproduction devices so as to record the data, in a distributed fashion, to the plurality of write-once information storage media, wherein
the plurality of recording and reproduction devices each record the data to the write-once information storage medium that is a recording object, of the plurality of write-once information storage media;
the write-once information storage media installed respectively in the plurality of recording and reproduction devices constitute a disk array;
the control unit detects that a fault has occurred in which the write-once information storage medium installed in any one of the plurality of recording and reproduction devices has become unable to perform recording; and
the backup recording and reproduction device alternatively records to the write-once alternative information storage medium data that ought to be recorded to a write-once faulty information storage medium in which the occurrence of a fault has been detected by the control unit,
when the control unit receives a reproduction request in relation to the write-once faulty information storage medium and when the area designated by the reproduction request is a recorded area of the write-once alternative information storage medium, then the control unit reproduces data from the write-once alternative information storage medium, and when the area designated by the reproduction request is an unrecorded area of the write-once alternative information storage medium and a recorded area of the write-once faulty information storage medium, then the control unit reproduces data from the write-once faulty information storage medium.

10. The information storage medium library array apparatus according to claim 9, wherein
each of the plurality of write-once information storage media has a user area where the data is recorded; and
the control unit copies all of the data in the recorded user area of the write-once faulty information storage medium, to the write-once alternative information storage medium, and when there is a recording request or a reproduction request in relation to the write-once faulty information storage medium, all the data of which has been copied, the control unit controls the backup recording and reproduction device so as to use the write-once alternative information storage medium.

11. The information storage medium library array apparatus according to claim 10, further comprising a cache memory, wherein
when an area designated by the reproduction request is an unrecorded area of the write-once alternative information storage medium and is a recorded area of the write-once faulty information storage medium, then the control unit reproduces data from the write-once faulty information storage medium and also stores the reproduced data in the cache memory; and
when copying all of the data of the recorded user area of the write-once faulty information storage medium, to the write-once alternative information storage medium, the control unit copies the data that has been stored in the cache memory, among all of the data, from the cache memory to the write-once alternative information storage medium.

12. The information storage medium library array apparatus according to claim 9, wherein
each of the plurality of write-once information storage media has a user area where the data is recorded;
the plurality of write-once information storage media have redundancy which enables restoration of data from another write-once information storage medium, even if at least one of the write-once information storage media which constitute the disk array cannot reproduce data; and
when the control unit receives a reproduction request for the disk array which is constituted by the plurality of write-once information storage media, all the user areas of which have been recorded, the control unit substitutes any of the plurality of write-once information storage media for the write-once faulty information storage medium, copies all of the data of the recorded user area of the write-once faulty information storage medium, to the write-once alternative information storage medium, and restores the data of the write-once information storage medium which has been substituted for the write-once faulty information storage medium, on the basis of data reproduced from the remaining write-once information storage media.

13. An information reproducing method for reproducing data from a plurality of write-once information storage media and a write-once alternative information storage medium which is a substitute for one of the plurality of write-once information storage media, wherein
each of the plurality of write-once information storage media and the write-once alternative information storage medium record data continuously on tracks,
the data is recorded to the write-once information storage medium that is a recording object, of the plurality of write-once information storage media; and
data that ought to be recorded to a write-once faulty information storage medium in which the occurrence of a fault has been detected, is recorded alternatively to the write-once alternative information storage medium
when a reproduction request is received in relation to the write-once faulty information storage medium and when the area designated by the reproduction request is a recorded area of the write-once alternative information storage medium, then data is reproduced from the write-once alternative information storage medium, and when the area designated by the reproduction request is an unrecorded area of the write-once alternative information storage medium and a recorded area of the write-once faulty information storage medium, then data is reproduced from the write-once faulty information storage medium.

14. A non-transitory computer readable recording medium storing an information reproduction program for reproducing data from a plurality of write-once information storage media and a write-once alternative information storage medium which is a substitute for one of the plurality of write-once information storage media, wherein
each of the plurality of write-once information storage media and the write-once alternative information storage medium record data continuously on tracks,
the data is recorded to the write-once information storage medium that is a recording object, of the plurality of write-once information storage media; and
data that ought to be recorded to a write-once faulty information storage medium in which the occurrence of a fault has been detected, is recorded alternatively to the write-once alternative information storage medium
the information reproduction program causing the computer to function as a reproduction unit in which, when a reproduction request is received in relation to the write-once faulty information storage medium and when the area designated by the reproduction request is a recorded area of the write-once alternative information storage medium, then data is reproduced from the write-once alternative information storage medium, and when the area designated by the reproduction request is an unrecorded area of the write-once alternative information storage medium and a recorded area of the write-once faulty information storage medium, then data is reproduced from the write-once faulty information storage medium.
